(19) United States
(12) Patent Application Publication
(10) Pub. No.: US 2019/0357593 A1
(43) Pub. Date: Nov. 28, 2019

(54) Electronic Cigarette

(71) Applicant: Acoustic Arc International Limited, Hong Kong (CN)

(72) Inventors: Boa Fung CHAU, Hong Kong (CN); Kak Man CHAN, Hong Kong (CN)

(21) Appl. No.: 15/997,859

(22) Filed: Jun. 5, 2018

Related U.S. Application Data
(60) Provisional application No. 62/676,307, filed on May 25, 2018.

(51) Int. Cl. A24F 47/00; A24D 1/14; A24F 9/04; A24F 1/02; A24F 13/02; H05B 7/10; H05B 7/144

(52) U.S. Cl. CPC A24F 47/008; A24D 1/14; A24F 9/04; H05B 7/144; A24F 13/02; H05B 7/10; A24F 1/02

(57) ABSTRACT

An electronic cigarette for smoldering tobacco materials housed in a cigarette cartridge has a heater, and first and second heat conductors. The heater generates heat by using a resistance wire, or via ionizing air, e.g., an electric arc generator. The first heat conductor, which receives heat from the heater, directly contacts an outer surface of the cigarette cartridge for heating the tobacco materials through the cigarette cartridge's outer surface. The second heat conductor penetrates into a center of the cigarette cartridge, and has a heating element for heating the tobacco materials via the cigarette cartridge's center. Hence, the tobacco materials are heated from both inside and outside of the cigarette cartridge simultaneously, thereby smoldering the tobacco materials more completely and resulting in a better taste. During ionizing the air, the heater may further generate a gaseous air-purifying agent for air purification, e.g., negative ions generated by the electric arc generator.

### CROSS-REFERENCE TO RELATED APPLICATIONS

This application claims the benefit of U.S. Provisional Patent Application No. 62/676,307, filed on May 25, 2018, which is incorporated by reference herein in its entirety.

### FIELD OF THE INVENTION

The present invention relates to an electronic cigarette.

### BACKGROUND

Although it is common sense that smoking is harmful to health, there are still a large number of smokers around the world. People are difficult to ignore smoking. An electronic cigarette, having a similar appearance and taste of a tobacco cigarette without harmful ingredient such as tar, is gaining popularity. Smoking with the electronic cigarette also lessens discomfort and psychological pain for an ex-smoker who gives up smoking. Furthermore, the electronic cigarette is more environmental-friendly and healthier than the tobacco cigarette.

Generally, the electronic cigarette includes a smoke oil type and a tobacco type. For a smoke oil-type electronic cigarette, people need to bring backup oil. However, oil sealing is one big issue for oil storage. While a tobacco-type electronic cigarette shares a similar appearance with a traditional tobacco cigarette, this electronic cigarette has no oil leakage concern. Hence, the tobacco-type electronic cigarette is a better choice for the ex-smoker.

Smoke vapor comes out generally by heating the cigarette cartridge with a resistance wire or a heater band, where the cigarette cartridge contains tobacco materials and the tobacco materials are smoldered or slowly burnt. However, such techniques have the follow drawbacks.
1) Typically, the cigarette cartridge is heated on its outer shell or its inside only, leading to insufficient heating to tobacco materials and limiting the heating area. Thereby, it gives rise to a low heating rate, low heating efficiency and a poor heating uniformity. Hence results in a commonly long pre-heating time and a waste of the tobacco materials.
2) Most attention on health issues related to electronic cigarettes has been focused on the treatment of chemicals' impact in the cigarettes, but the influence of bacteria in tobacco and air contamination has been overlooked. Research published in Environmental Health Perspectives with a title of Human Pathogens Abundant in the Bacterial Metagenome of Cigarettes in 2010 has shown that smokers could even inhale live bacteria through the smoke. Therefore, the potential threat of bacteria and air contamination should take into serious consideration.
3) Tobacco trash and other dirties can stick on to the resistance wire after high temperature heating, and the dirt-contaminated resistance wire leads to a poor heating efficiency. Also, the dirty tobacco trash affects the lifetime of the resistance wire as well. Meanwhile, the repeated use of the dirty resistance wire causes a very high temperature in heating the tobacco, creating a high chance for the tobacco to generate harmful substances and hence affecting human health. Current techniques generally need to open the electronic cigarette and to remove the tobacco trash by external tools such as cotton swab or other similar tools, which is neither convenient nor user friendly. Hence, a highly integrated and easier-to-manipulate cleaning tool is in need.

Therefore, there is a need in the art to provide an electronic cigarette that solves the above-listed problems.

### SUMMARY OF THE INVENTION

The present invention provides an electronic cigarette for smoldering tobacco materials. The tobacco materials are housed in a cigarette cartridge insertable into the electronic cigarette. The electronic cigarette comprises a heater, a first heat conductor and a second heat conductor. The heater can be selected from a wire resistor, an electric arc generator, an ozonator, an anion generator, a corona discharge device, an electromagnetic heater, a laser heater or other heating methods. The first heat conductor is connected to the heater for receiving heat therefrom. Furthermore, the first heat conductor is arranged to directly contact an outer surface of the cigarette cartridge for heating the tobacco materials through the cigarette cartridge's outer surface when the cigarette cartridge is inserted into the electronic cigarette. The second heat conductor is arranged to penetrate into a center of the cigarette cartridge for heating the tobacco materials via the cigarette cartridge's center when the second heat conductor is powered and when the cigarette cartridge is inserted into the electronic cigarette. In particular, the heater and the second heat conductor are arranged to provide heat simultaneously. By the first and second heat conductors, the tobacco materials are heated from both inside and outside of the cigarette cartridge simultaneously during the smoldering of the tobacco materials, so that the tobacco materials is smoldered more completely, resulting in a better taste.

Take an example for illustration. The heater is an electric arc generator. The electric arc generator may include one or more pairs of electrodes. Each of the electrodes pairs is used for generating an electric arc. The electronic cigarette may further comprise a voltage-multiplying circuit for boosting up a voltage supplied by a battery to generate a boost-up voltage, and for powering the electric arc generator with the boost-up voltage to generate an electric arc. The voltage supplied by the battery is also used for powering the second heat conductor.

According to one embodiment of the present invention, the electronic cigarette further comprises a shell, a cigarette holder on one end of the shell for holding the cigarette cartridge, and a cleaning system positioned in the shell and movable towards the cigarette holder, where the cleaning system is configured to push off smoke trash from inside the electronic cigarette during moving towards the cigarette holder. The electronic cigarette may further comprise a moving unit mounted to the cleaning system for facilitating the cleaning system to move to and fro the cigarette holder. The cleaning system may include a plate for pushing off the smoke trash.

According to another embodiment of the present invention, the second heat conductor includes a heat transfer rod arranged to penetrate inside the cigarette cartridge for transferring heat to the tobacco materials via the cigarette cartridge's center, and a heating element for heating the heat transfer rod when the second heat conductor is powered. Preferably, the heating element is a resistance wire.

In one embodiment, advantageously the heater is further configured to generate a gaseous air-purifying agent for air purification during ionizing the air. The second heat conductor is connected to the heater for delivering the gaseous air-purifying agent to the cigarette cartridge's center, at which the gaseous air-purifying agent is released. The second heat conductor may further include a transmitting terminal tip attached to the heat transfer rod for releasing the gaseous air-purifying agent at the cigarette cartridge's center.

In one implementation of the heater used for generating the gaseous air-purifying agent, the heater is an electric arc generator and the gaseous air-purifying agent is negative ions. Alternatively, the heater may be selected from an electric arc generator, an ozonator, an anion generator and a corona discharge device.

Other aspects of the present invention are disclosed as illustrated by the embodiments hereinafter.

### BRIEF DESCRIPTION OF THE DRAWINGS

FIG. 1 depicts, in accordance with an exemplary embodiment of the present invention, an electronic cigarette having a cigarette cartridge therein.

FIG. 2 depicts, in accordance with the exemplary embodiment, an exploded view of the electronic cigarette of FIG. 1.

FIG. 3 depicts an exploded view of a second heat conductor used in the disclosed electronic cigarette according to one embodiment of the present invention.

FIG. 4 depicts a realization of a cleaning system used in the disclosed electronic cigarette according to one embodiment of the present invention.

### DETAILED DESCRIPTION

An aspect of the present invention is to provide an electronic cigarette. As will be shown hereinafter, potential advantages of the disclosed electronic cigarette include the capability of realizing rapid heating and low power consumption, and the ability of smoldering the tobacco materials housed in a cigarette cartridge from both inside and outside thereof. The electronic cigarette may additionally include a function of air purification for making the air clean. A further potential advantage of the electronic cigarette is that it can be cleaned very easily.

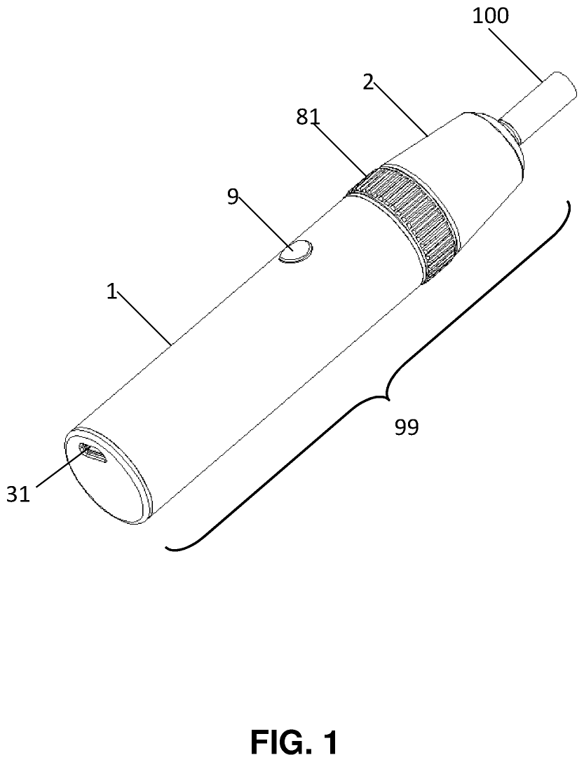

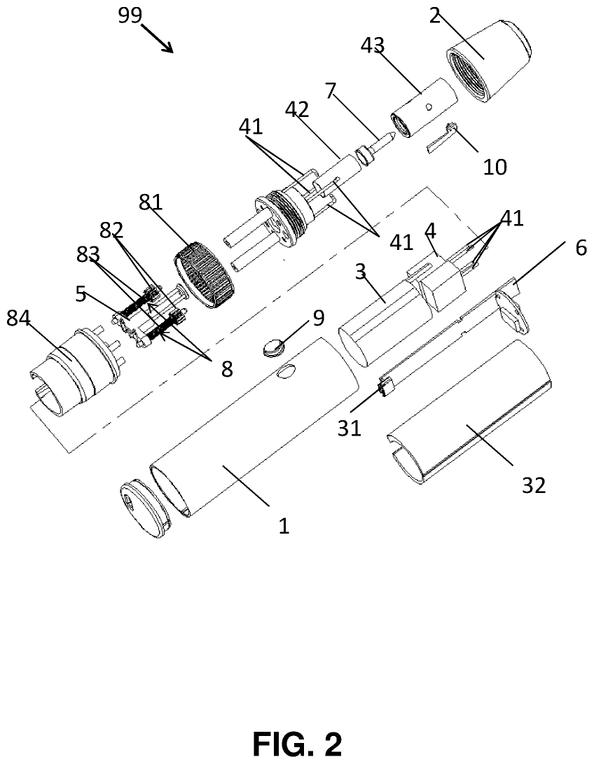

Exemplarily, the disclosed electronic cigarette is illustrated with the aid of FIGS. 1 and 2. FIG. 1 depicts an electronic cigarette 99 having a cigarette cartridge 100 therein. In accordance with an exemplary embodiment of the present invention, an exploded view of the electronic cigarette 99 is depicted in FIG. 2. The electronic cigarette 99 has a principal function of smoldering tobacco materials. Generally, the electronic cigarette 99 can have different shapes, such as cubic, cuboid, cylindrical or any combination thereof. During operation of the electronic cigarette 99, the tobacco materials are housed in a cigarette cartridge 100. Typically, the cigarette cartridge 100 has a cylindrical shape. The cigarette cartridge 100 is insertable into the electronic cigarette 99. During operation of the electronic cigarette 99, the cigarette cartridge 100 is inserted into the electronic cigarette 99.

Refer to FIGS. 1 and 2. The electronic cigarette 99 includes a shell 1, and a cigarette holder 2 on one end of the shell 1 for holding the cigarette cartridge 100. A battery 3 is installable in the electronic cigarette 99. Particularly, the battery 3 is installed inside the shell 1, and is positioned to connect to a heater 4 for heating the tobacco materials that are housed in the cigarette cartridge 100. The heater 4 can generate heat via a wire resistor, an electric arc generator, an ozonator, an anion generator, a corona discharge device, an electromagnetic heater or a laser heater or other heating methods. For advantages that will become apparent soon, the heater 4 is preferably configured to generate heat via ionizing air. An example of the heater 4 is an electric arc generator that can generate heat via ionizing air. The heater 4 is connected to a first heat conductor 42 so that the first heat conductor 42 receives heat from the heater 4 during operation. When the cigarette cartridge 100 is inserted in the electronic cigarette 99, the first heat conductor 42 in turn contacts an outer surface of the cigarette cartridge 100 directly. Thereby, the tobacco materials are heated through the outer surface of the cigarette cartridge 100. The battery 3 is also connected to a second heat conductor 7. The second heat conductor 7 is configured to penetrate into the center of the cigarette cartridge 100 during operation.

One optional but advantageous feature of the heater 4 that generates heat via ionizing the air is that the heater 4 may be further configured to function as an air purifier that produces gaseous air-purifying agent, such as ozone and negative ions, during ionizing the air. The heater/air purifier 4 may be implemented, e.g., as an ozonator, an anion generator, or a corona discharge device. According to one preferred embodiment of the present invention, the heater/air purifier 4 is realized by an electric arc generator for heat generation, where the electric arc generator also functions as an anion generator for producing negative ions. For convenience in illustrating the present invention, hereinafter the electronic cigarette 99 is illustrated by considering an exemplary case that the heater 4 or the heater/air purifier 4 is the electronic arc generator (also referenced as 4).

The electric arc generator 4 can preferably serve as an air purifier, where the air purifier as considered is an anion generator for generating negative ions. The air around a transmitting terminal tip 74 can be cleaned by the negative ions. Bacteria around the second heat conductor 7 and the cigarette holder 2 can be repelled and can even be killed to some extent. Additionally, the negative ions can be generated straightly before each generation of the smoke so as to eliminate the bacteria first. The generation of the negative ions can be switched on or off independently, depending on the user's demand. Furthermore, the negative ions can interact with gas molecules through physical absorption, electrical neutralization or even chemical reactions. As a result, the negative ions can be used to eliminate unpleasant odor and keep the user feeling clean and refreshed. Moreover, the electronic cigarette 99 is equipped with a cleaning system 5. The cleaning system 5 is mounted to a moving unit 8. The moving unit 8 can facilitate the cleaning system 5 to move to and fro the cigarette holder 2.

With the above-mentioned structure of the electronic cigarette 99, a high voltage can be generated by the electric arc generator 4. A high-temperature electric arc is then generated, so that the outside of the cigarette cartridge 100 is rapidly heated and can be heated to a higher temperature. Additionally, the heater 4 and the second heat conductor 7 are arranged to provide heat simultaneously. Thereby, the inside of the cigarette cartridge 100 is simultaneously heated via the second heat conductor 7. Since both the outside and inside of the cigarette cartridge 100 are heated simultaneously, tobacco materials in the cigarette cartridge 100 are smoldered more completely and hence it results in a better taste. Advantageously, the electric arc generator 4 has a longer life time when compared to a resistance wire. Additionally, the electric arc generator 4 may serve as an anion generator. The anion generator can ionize air and produce negative ions. The negative ions are released into the air through the transmitting terminal tip 74. With the beneficial action of negative ions, the air inside the electronic cigarette 99 can be purified and bacteria in the air can be repelled or even get killed. Furthermore, through the cleaning system 5, which is movable towards to the cigarette holder 2, smoke trash and other dirt can be pushed off from the electronic cigarette 99 very easily, thereby maintaining a clean working environment of the electronic cigarette 99. In one embodiment, the cleaning system 5 includes a plate 52 pushing off the smoke trash and other dirt. As an advantageous result, potentially harmful substances that could be generated by repeated heating of a dirty resistance wire can be avoided.

Specifically, the electric arc generator 4 includes one or more pairs of electrodes 41 and a voltage-multiplying circuit (not shown in FIG. 2) that can boost up a voltage supplied by the battery 3 to yield a boost-up voltage. The voltage of the battery 3 is increased to thousands of volts by the voltage-multiplying circuit and the boost-up voltage is used to power the electric arc generator 4 by applying the boost-up voltage between each pair of electrodes 41. The air between each pair of electrodes 41 is ionized and an electric arc is generated. The high-temperature electric arc transfers its thermal energy to the first heat conductor 42 and finally the cigarette cartridge 100 is heated on its outer surface. Meanwhile, the second heat conductor 7 is powered by the battery 3 to generate heat. The heat is transferred to the center of the cigarette cartridge 100. Hence, the tobacco materials are heated from both outside and inside of the cigarette cartridge 100 simultaneously such that smoke vapor is generated for the user to smoke.

The electronic cigarette 99 also includes a heat insulate housing 43 arranged such that the one or more pairs of electrodes 41 are hidden inside the heat insulate housing 43. In order to increase the heat efficiency of electric arc generation, preferably more-than-one pairs of electrodes 41 are equipped.

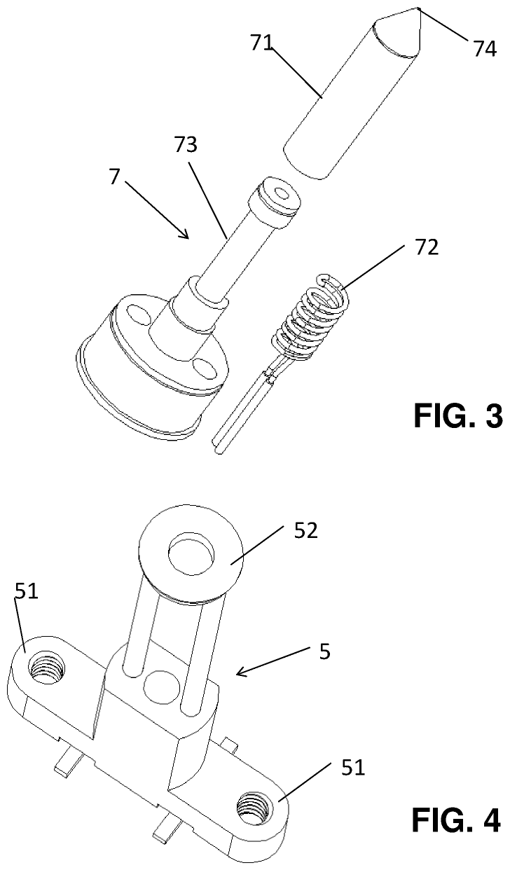

FIG. 3 depicts an exploded view of the second heat conductor 7 according to one embodiment of the present invention. The second heat conductor 7 includes a heat transfer rod 71. The heat transfer rod 71 can be inserted inside, and hence penetrated into, the cigarette cartridge 100. The heat transfer rod 71 can be heated. The shape of the heat transfer rod 71 can be a cylinder or a square column. The outside of the heat transfer rod 71 can also be equipped with one or more cooling fins (not shown in FIG. 3). The one or more cooling fins can be of any shape as deemed appropriate by those skilled in the art; the present invention does not impose any limitation on the shape of each cooling fin. Preferably, stainless steel is used to make the heat transfer rod 71. The center of heat transfer rod 71 is made hollowed and is inserted with a copper rod 73 due to the high thermal conductivity of copper. Since harmful substances can be generated if copper is heated at a high temperature, the copper rod 73 is put inside the heat transfer rod 71 to avoid the aforementioned harmful-substance generation problem. Furthermore, the presence of the copper rod 73 inside the heat transfer rod 71 is helpful to increase the mechanical strength of the heat transfer rod 71 as well. Outside the copper rod 73, there is installed a heating element 72 used for heating copper rod 73. For implementation simplicity, the heating element 72 is preferably realized by a resistance wire. The heating element 72 is connected to a controller 6 as well. As the electric arc generator 4 heats the outside of the cigarette cartridge 100 and the thermal energy is transferred to the inside of the cigarette cartridge 100 as well, the resistance wire that is used as the heating element 72 only needs to be powered to heat up to 200° C. In comparison to traditional tobacco-heating technology, which typically heats up the resistance wire to 300° C., the heating element 72 has a lower power consumption. Furthermore, a relatively low temperature used in heating the copper rod 73 can help to protect it from over-heating damage.

According to one embodiment of the present invention, the moving unit 8 includes a first moving unit connected to the shell 1. The first moving unit is connected to the cigarette holder 2, and the first moving unit is connected to a second moving unit. The second moving unit includes a transmission unit used to connect to the first moving unit. The transmission unit is connected with a moving unit, where the moving unit is a screw rod 83. The screw rod 83 is screw-joint to the cleaning system 5, where the cleaning system 5 can move linearly along with the axis of the screw rod 83.

FIG. 4 depicts a realization of the cleaning system 5 according to one embodiment of the present invention. As shown in FIG. 4, there is a fastener board 51 having threaded screw holes for connecting to the screw rod 83 on both sides of cleaning system 5. A mounting housing 84 is also equipped in the moving unit 8 for fixing the first moving unit and the cleaning system 5. Inside the mounting housing 84, a special structure is designed to confine the movement of the fastener board 51 from rotation of the screw rod 83, so as to make sure producing a linear movement of the fastener board 51 along the axis of the screw rod 83. According to one embodiment of the present invention, the first moving unit is a gear ring 81 and the second moving unit is a gear 82 where the gear 82 is engaged with the gear ring 81. The gear 82 is arranged to rotate with the movement of the gear ring 81. The screw rod 83 is arranged to rotate with the rotation of the gear 82. Rotation of the screw rod 83 then drives the cleaning system 5 to move linearly along the axis of the screw rod 83 or the heat transfer rod 71. In other words, the cleaning system 5 is driven by the moving unit 8 to move towards to the cigarette holder 2. This arrangement is helpful to clean the cleaning system 5 by external cleaning tools. Meanwhile, the cleaning system 5 can also move back to its original working position.

The electronic cigarette 99 further includes the controller 6. The controller 6 is connected with the heater/air purifier 4, the second heat conductor 7 or the battery 3. The controller 6 is capable of controlling the heater 4 to periodically work. As mentioned above, the heater 4 is preferably the electric arc generator 4. Since the electric arc temperature generated by the electric arc generator 4 is relatively high, the temperature of the first heat conductor 42 continues to increase if the electric arc continues to be generated. When the temperature exceeds the ignition temperature of the cigarette cartridge 100, the cigarette cartridge 100 is directly burned out. The first heat conductor 42 is also damaged, making the electronic cigarette 99 unable to work properly or even causing safety accidents. Therefore, the controller 6 is connected to the battery 3, and the controller 6 periodically and electrically connects and disconnects the electric arc generator 4 from the battery 3. Hence, the electric arc generator 4 periodically generates the electric arc, thereby realizing periodic heating of the first heat conductor 42. Alternatively, the controller 6 may be directly electrically connected to the electric arc generator 4. The controller 6 directly controls the voltage multiplying circuit in the electric arc generator 4 to periodically generate a high and a low voltage, thereby realizing the periodic high- and low-temperature heat of the first heat conductor 42. Hence, it is ensured that the cigarette cartridge 100, which is inserted into the electronic cigarette 99, can always be in a smoldering state.

Preferably, the electronic cigarette 99 further includes a start switch 9 for starting work of the electronic cigarette 99, and a safety switch 10 capable of sensing whether the cigarette cartridge 100 is inserted into the electronic cigarette 99. The start switch 9, the safety switch 10 and the electric arc generator 4 are all electrically connected to the controller 6. The safety switch 10 can be disposed on the first heat conductor 42 or the cigarette holder 2. According to one embodiment of the present invention, the safety switch 10 is disposed at the cigarette holder 2, and the safety switch 10 can be a proximity switch or another switch such as an auto reset micro switch. If the cigarette cartridge 100 is inserted into the electronic cigarette 99, the safety switch 10 is closed, then the start switch 9 is closed, the electric arc generator 4 generates an electric arc, and the electronic cigarette 99 works normally. If the cigarette cartridge 100 is not inserted into the electronic cigarette 99, the safety switch 10 is disconnected. At this moment, even if the start switch 9 is closed, the electric arc generator 4 cannot generate the electric arc, and the electronic cigarette 99 cannot work. It can be seen that by setting the two-stage mechanism of operating the safety switch 10 and the start switch 9, safety on the use of the electronic cigarette 99 is improved, thereby avoiding the situation that the cigarette cartridge 100 is not inserted in the electronic cigarette 99 but the electric arc generator 4 is started somehow and the electronic cigarette 99 can be damaged therefor.

The battery 3 installed in the electronic cigarette 99 may be a disposable battery power source or a rechargeable battery power source. Preferably and advantageously, the electronic cigarette 99 adopts a rechargeable battery power source, and the charging interface 31 of the electronic cigarette 99 is disposed at one end of the shell 1 away from the cigarette holder 2.

The battery 3 may be integrated to the electronic cigarette 99 as one unit, or may be arranged to be a removable unit not belonging to the electronic cigarette 99. The latter arrangement is useful when it is expected to replace the battery 3 from time to time. The battery 3 may be a rechargeable battery or an ordinary battery.

Obviously, the above-disclosed embodiments of the present invention are merely examples for clearly illustrating the present invention, rather than limiting the present invention. For those skilled in the art, other variations or changes may be made on the basis of the above description. There is no need and no exhaustion for all of the embodiments. Any modification, equivalent replacement and improvement made within the spirit and principle of the present invention should be included in the protection scope of the appended claims of the present invention.

What is claimed is:

1. An electronic cigarette for smoldering tobacco materials, the tobacco materials being housed in a cigarette cartridge insertable into the electronic cigarette, the electronic cigarette comprising:
a heater;
a first heat conductor connected to the heater for receiving heat therefrom, the first heat conductor being arranged to directly contact an outer surface of the cigarette cartridge for heating the tobacco materials through the cigarette cartridge's outer surface when the cigarette cartridge is inserted into the electronic cigarette; and
a second heat conductor arranged to penetrate into a center of the cigarette cartridge for heating the tobacco materials via the cigarette cartridge's center when the second heat conductor is powered and when the cigarette cartridge is inserted into the electronic cigarette, wherein the heater and the second heat conductor are arranged to provide heat simultaneously, thereby heating the tobacco materials from both inside and outside of the cigarette cartridge simultaneously in the smoldering of the tobacco materials.

2. The electronic cigarette of claim 1, wherein the heater is selected from a wire resistor, an electric arc generator, an ozonator, an anion generator, a corona discharge device, an electromagnetic heater or a laser heater.

3. The electronic cigarette of claim 2 further comprising a voltage-multiplying circuit for boosting up a voltage supplied by a battery to generate a boost-up voltage, and for powering the electric arc generator with the boost-up voltage to generate an electric arc, wherein the voltage supplied by the battery is also used for powering the second heat conductor.

4. The electronic cigarette of claim 2, wherein the electric arc generator includes one or more pairs of electrodes, each of the electrodes pairs being used for generating an electric arc.

5. The electronic cigarette of claim 1 further comprising:
a shell;
a cigarette holder on one end of the shell for holding the cigarette cartridge; and
a cleaning system positioned in the shell and movable towards the cigarette holder, the cleaning system being configured to push off smoke trash from inside the electronic cigarette during moving towards the cigarette holder.

6. The electronic cigarette of claim 5 further comprising a moving unit mounted to the cleaning system for facilitating the cleaning system to move to and fro the cigarette holder.

7. The electronic cigarette of claim 5, wherein the cleaning system includes a plate for pushing off the smoke trash.

8. The electronic cigarette of claim 1, wherein the second heat conductor includes:
a heat transfer rod arranged to penetrate inside the cigarette cartridge for transferring heat to the tobacco materials via the cigarette cartridge's center; and
a heating element for heating the heat transfer rod when the second heat conductor is powered.

9. The electronic cigarette of claim 8, wherein the heating element is a resistance wire.

10. The electronic cigarette of claim 1, wherein:
the heater is configured to generate heat via ionizing air and to generate a gaseous air-purifying agent for air purification during ionizing the air; and
the second heat conductor is connected to the heater for delivering the gaseous air-purifying agent to the cigarette cartridge's center, at which the gaseous air-purifying agent is released.

11. The electronic cigarette of claim 10, wherein the second heat conductor includes:
a heat transfer rod arranged to penetrate inside the cigarette cartridge for transferring heat to the tobacco materials via the cigarette cartridge's center; and
a transmitting terminal tip attached to the heat transfer rod for releasing the gaseous air-purifying agent at the cigarette cartridge's center.

12. The electronic cigarette of claim 10, wherein the heater is an electric arc generator and the gaseous air-purifying agent is negative ions.

13. The electronic cigarette of claim 12 further comprising a voltage-multiplying circuit for boosting up a voltage supplied by a battery to generate a boost-up voltage, and for powering the electric arc generator with the boost-up voltage to generate an electric arc, wherein the voltage supplied by the battery is also used for powering the second heat conductor.

14. The electronic cigarette of claim 12, wherein the electric arc generator includes one or more pairs of electrodes, each of the electrodes pairs being used for generating an electric arc.

15. An electronic cigarette for smoldering tobacco materials, the tobacco materials being housed in a cigarette cartridge insertable into the electronic cigarette, the electronic cigarette comprising:
a heater configured to generate heat via ionizing air for heating the tobacco materials, and to generate a gaseous air-purifying agent for air purification during ionizing the air.

16. The electronic cigarette of claim 15, wherein the heater is an electric arc generator and the gaseous air-purifying agent is negative ions.

17. An electronic cigarette for smoldering tobacco materials, the tobacco materials being housed in a cigarette cartridge insertable into the electronic cigarette, the electronic cigarette comprising:
a shell;
a cigarette holder on one end of the shell for holding the cigarette cartridge; and
a cleaning system positioned in the shell and movable towards the cigarette holder, the cleaning system being configured to push off smoke trash from inside the electronic cigarette during moving towards the cigarette holder.

18. The electronic cigarette of claim 18 further comprising a moving unit mounted to the cleaning system for facilitating the cleaning system to move to and fro the cigarette holder.

19. The electronic cigarette of claim 18, wherein the cleaning system includes a plate for pushing off the smoke trash.
